(19) United States
(12) Patent Application Publication
(10) Pub. No.: US 2017/0325230 A1
(43) Pub. Date: Nov. 9, 2017

(54) FREQUENCY BAND AND CHANNEL SELECTION FOR A NEIGHBOR AWARENESS NETWORK (NAN) DATA LINK (NDL)

(71) Applicant: QUALCOMM Incorporated, San Diego, CA (US)

(72) Inventors: Santosh ABRAHAM, San Diego, CA (US); Abhishek Pramod PATIL, San Diego, CA (US); George CHERIAN, San Diego, CA (US); Alireza RAISSINIA, Monte Sereno, CA (US); Shivraj Singh SANDHU, Milpitas, CA (US)

(21) Appl. No.: 15/587,338

(22) Filed: May 4, 2017

Related U.S. Application Data
(60) Provisional application No. 62/333,736, filed on May 9, 2016.

(51) Int. Cl. H04W 72/04; H04W 72/08; H04L 29/08; H04W 76/02

(52) U.S. Cl. CPC H04W 72/0453; H04W 76/027; H04W 76/023; H04L 67/16; H04W 72/042; H04W 72/08

(57) ABSTRACT

This disclosure provides systems, methods and apparatus, including computer programs encoded on computer storage media, for wireless communication over a neighbor awareness networking (NAN) data link (NDL). In some aspects, an apparatus may be configured to determine frequency band information for communicating over a NDL associated with a NAN service. In some other aspects, the apparatus may be configured to provide the determined frequency band information for transmission to a subscriber of the NAN service for setting up the NDL.

### CROSS-REFERENCE TO RELATED APPLICATION(S)

This application claims the benefit of U.S. Provisional Application Ser. No. 62/333,736, entitled “FREQUENCY BAND AND CHANNEL SELECTION FOR A NAN DATA LINK” and filed on May 9, 2016, which is expressly incorporated by reference herein in its entirety.

### TECHNICAL FIELD

The present disclosure relates generally to communication systems, and more particularly, to frequency band selection and channel selection within a frequency band for a neighbor awareness networking (NAN) data link (NDL).

### DESCRIPTION OF THE RELATED TECHNOLOGY

In telecommunication systems, communications networks are used to exchange messages among several interacting spatially-separated devices. Networks may be classified according to geographic scope, for example, by metropolitan area, local area, or personal area. Such networks may be designated respectively as a wide area network (WAN), metropolitan area network (MAN), local area network (LAN), wireless local area network (WLAN), or personal area network (PAN). Networks also differ according to the switching and routing techniques used to interconnect the various network nodes and devices (such as circuit switching or packet switching), the type of physical media employed for transmission (such as wired or wireless), and the set of communication protocols used (such as Internet protocol suite, Synchronous Optical Networking (SONET), Ethernet, etc.).

In the foregoing networks, devices may form a neighbor awareness networking (NAN) network and discover the capabilities of other nearby devices within the NAN network.

### SUMMARY

The systems, methods and devices of this disclosure each have several innovative aspects, no single one of which is solely responsible for the desirable attributes disclosed herein.

One innovative aspect of the subject matter described in this disclosure can be implemented in an apparatus configured to determine frequency band information for communicating over a neighbor awareness networking (NAN) data link (NDL) associated with a NAN service, and to provide the determined frequency band information for transmission to a subscriber of the NAN service for setting up the NDL.

In some implementations, the apparatus can be configured to receive a service discovery message from the subscriber. In some other implementations, the determined frequency band information can be transmitted in response to the received service discovery message

In some implementations, the determined frequency band information can be transmitted in a publish message. In some other implementations, the determined frequency band information can be included in a usage preference subfield of an entry control field within an availability entry attribute that can be included within the publish message. In some other implementations, the usage preference subfield can indicate a ranking of one or more frequency bands among possible frequency bands for connection setup.

In some implementations, the apparatus can be configured to provide one or more periods indicating when the apparatus is available for connection setup based on the determined frequency band information. In some other implementations, when the connection setup for the NDL is successful on a frequency band indicated in the frequency band information, the NDL can be established on the frequency band. In some other implementations, the frequency band can be different from a second frequency band on which the frequency band information was transmitted.

In some implementations, the apparatus can be configured to provide an indication of connection setup failure if connection setup failure is detected. In some other implementations, the indication can include a reason code for the connection setup failure.

Another innovative aspect of the subject matter described in this disclosure can be implemented in a method that includes determining frequency band information for communicating over a NDL associated with a NAN service, and determining frequency band information for transmission to a subscriber of the NAN service for setting up the NDL.

In some implementations, the method can include receiving a service discovery message from the subscriber. In some other implementations, the determined frequency band information can be transmitted in response to the received service discovery message

In some implementations, the determined frequency band information can be transmitted in a publish message. In some other implementations, the determined frequency band information can be included in a usage preference subfield of an entry control field within an availability entry attribute that can be included within the publish message. In some other implementations, the usage preference subfield can indicate a ranking of one or more frequency bands among possible frequency bands for connection setup.

In some implementations, the method can include providing one or more periods indicating when connection setup is available based on the determined frequency band information. In some other implementations, when the connection setup for the NDL is successful on a frequency band indicated in the frequency band information, the NDL can be established on the frequency band. In some other implementations, the frequency band can be different from a second frequency band on which the frequency band information was transmitted.

In some implementations, the method can include providing an indication of connection setup failure if connection setup failure is detected. In some other implementations, the indication can include a reason code for the connection setup failure.

Another innovative aspect of the subject matter described in this disclosure can be implemented in an apparatus that includes means for determining frequency band information for communicating over a NDL associated with a NAN service, and means for providing the determined frequency band information for transmission to a subscriber of the NAN service for setting up the NDL.

In some implementations, the apparatus can include means for receiving a service discovery message from the subscriber. In some other implementations, the determined frequency band information can be transmitted in response to the received service discovery message

In some implementations, the determined frequency band information can be transmitted in a publish message. In some other implementations, the determined frequency band information can be included in a usage preference subfield of an entry control field within an availability entry attribute that can be included within the publish message. In some other implementations, the usage preference subfield can indicate a ranking of one or more frequency bands among possible frequency bands for connection setup.

In some implementations, the apparatus can include means for providing one or more periods indicating when the apparatus is available for connection setup based on the determined frequency band information. In some other implementations, when the connection setup for the NDL is successful on a frequency band indicated in the frequency band information, the NDL can be established on the frequency band. In some other implementations, the frequency band can be different from a second frequency band on which the frequency band information was transmitted.

In some implementations, the apparatus can include means for providing an indication of connection setup failure if connection setup failure is detected. In some other implementations, the indication can include a reason code for the connection setup failure.

Another innovative aspect of the subject matter described in this disclosure can be implemented in a computer-readable medium that includes code to determine frequency band information for communicating over a NDL associated with a NAN service, and to provide the determined frequency band information for transmission to a subscriber of the NAN service for setting up the NDL.

In some implementations, the computer-readable medium can include code to receive a service discovery message from the subscriber. In some other implementations, the determined frequency band information can be transmitted in response to the received service discovery message

In some implementations, the determined frequency band information can be transmitted in a publish message. In some other implementations, the determined frequency band information can be included in a usage preference subfield of an entry control field within an availability entry attribute that can be included within the publish message. In some other implementations, the usage preference subfield can indicate a ranking of one or more frequency bands among possible frequency bands for connection setup.

In some implementations, the computer-readable medium can include code to provide one or more periods indicating when the connection setup is available based on the determined frequency band information. In some other implementations, when the connection setup for the NDL is successful on a frequency band indicated in the frequency band information, the NDL can be established on the frequency band. In some other implementations, the frequency band can be different from a second frequency band on which the frequency band information was transmitted.

In some implementations, the computer-readable medium can include code to provide an indication of connection setup failure if connection setup failure is detected. In some other implementations, the indication can include a reason code for the connection setup failure.

Another innovative aspect of the subject matter described in this disclosure can be implemented in an apparatus configured to receive, from a second apparatus, a message that comprises frequency band information for communicating over a NDL associated with a NAN service, to select a frequency band for communicating over the NDL based on the received frequency band information, and to attempt to setup a connection with the second apparatus over the NDL based on the selected frequency band.

In some implementations, the apparatus can be configured to attempt to setup the connection by determining if the apparatus is able to communicate with the second apparatus on the selected frequency band, and determining a link quality with the second apparatus based on the selected frequency band if the apparatus is able to communicate with the second apparatus on the selected frequency.

In some implementations, the apparatus can be configured to provide an indication of connection setup failure if connection setup failure is detected. In some other implementations, the indication can include a reason code for the connection setup failure.

Another innovative aspect of the subject matter described in this disclosure can be implemented in a method for a first apparatus that includes receiving, from a second apparatus, a message that comprises frequency band information for communicating over a NDL associated with a NAN service, selecting a frequency band for communicating over the NDL based on the received frequency band information, and attempting to setup a connection with the second apparatus over the NDL based on the selected frequency band.

In some implementations, the method can include attempting to setup the connection by determining if the first apparatus is able to communicate with the second apparatus on the selected frequency band, and determining a link quality with the second apparatus based on the selected frequency band if the first apparatus is able to communicate with the second apparatus on the selected frequency.

In some implementations, the method can include providing an indication of connection setup failure if connection setup failure is detected. In some other implementations, the indication can include a reason code for the connection setup failure.

Another innovative aspect of the subject matter described in this disclosure can be implemented in an apparatus that includes means for receiving, from a second apparatus, a message that comprises frequency band information for communicating over a NDL associated with a NAN service, means for selecting a frequency band for communicating over the NDL based on the received frequency band information, and means for attempting to setup a connection with the second apparatus over the NDL based on the selected frequency band.

In some implementations, the means for attempting to setup the connection can be configured to determine if the apparatus is able to communicate with the second apparatus on the selected frequency band, and determine a link quality with the second apparatus based on the selected frequency band if the apparatus is able to communicate with the second apparatus on the selected frequency.

In some implementations, the apparatus can include means for providing an indication of connection setup failure if connection setup failure is detected. In some other implementations, the indication can include a reason code for the connection setup failure.

Another innovative aspect of the subject matter described in this disclosure can be implemented in a computer-readable medium including code to receive, from a second apparatus, a message that comprises frequency band information for communicating over a NDL associated with a NAN service, select a frequency band for communicating over the NDL based on the received frequency band information, and attempt to setup a connection with the second apparatus over the NDL based on the selected frequency band.

In some implementations, the code to attempt to setup the connection can be configured to determine if the apparatus is able to communicate with the second apparatus on the selected frequency band, and determine a link quality with the second apparatus based on the selected frequency band if the apparatus is able to communicate with the second apparatus on the selected frequency.

In some implementations, the computer-readable medium can include code to provide an indication of connection setup failure if connection setup failure is detected. In some other implementations, the indication can include a reason code for the connection setup failure.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example wireless communication system.

FIG. 2A is a diagram of an example neighbor awareness networking (NAN) cluster.

FIG. 2B is a diagram of an example communication interval in a NAN.

FIG. 3 illustrates a diagram of an example NAN availability attribute format.

FIG. 4 illustrates an example service descriptor extension attribute.

FIG. 5 shows an example functional block diagram of a wireless device that may provide information for band selection and perform band selection within the wireless communication system of FIG. 1.

FIG. 6 is a flowchart of an example method for enabling band selection.

FIG. 7 is a flowchart of an example method for performing band selection.

FIG. 8 is a functional block diagram of an example wireless communication device that provides information for and performs band selection.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving RF signals according to any of the IEEE 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IoT) network, such as a system utilizing 3G, 4G, or 5G, or further implementations thereof, technology.

Devices may form a network and then discover the capabilities of other devices within the network. Neighbor awareness networking (NAN), also known as social Wi-Fi networks, may provide another networking approach in which devices advertise services to nearby devices or discover the services of nearby devices. A NAN network may provide beaconing, synchronization, and small advertisement and subscription frames that allow devices to advertise services and discover services. One purpose of a NAN network may be to aid service discovery within a one-hop range (no device relaying information between two devices) of a discovering device.

To improve data throughput in NAN communications, device discovery between a publisher device providing the service and a subscriber device requesting the service may occur on a first channel (such as a discovery channel), and NAN communications, including data link setup, may occur on a second channel that supports higher throughput. For example, device discovery between the publisher and subscriber devices may occur on channel 6 in the 2.4 GHz band, for example, while the connection setup may occur on the 60 GHz band that provides higher throughput. In some aspects, the publisher device may indicate one or more options for the second channel with higher throughput potential, and the subscriber device may attempt to perform connection setup using one of the indicated options. Depending on the distance between the devices, the publisher and subscriber devices may be able to communicate over the 2.4 GHz band but not the 60 GHz band.

Particular implementations of the subject matter described in this disclosure can be implemented to realize one or more of the following potential advantages. To ensure that the publisher and subscriber devices attempt connection setup over channels that are compatible with both devices, the publisher device may provide frequency band information that indicates the channel preferences of the publisher device. The subscriber device may then select a channel indicated in the frequency band information to attempt connection setup. As part of the connection setup, the publisher and subscriber devices also may exchange information regarding the link quality between the devices to determine whether the connection setup will succeed using a currently selected channel or frequency band or whether connection setup should be attempted over a different channel.

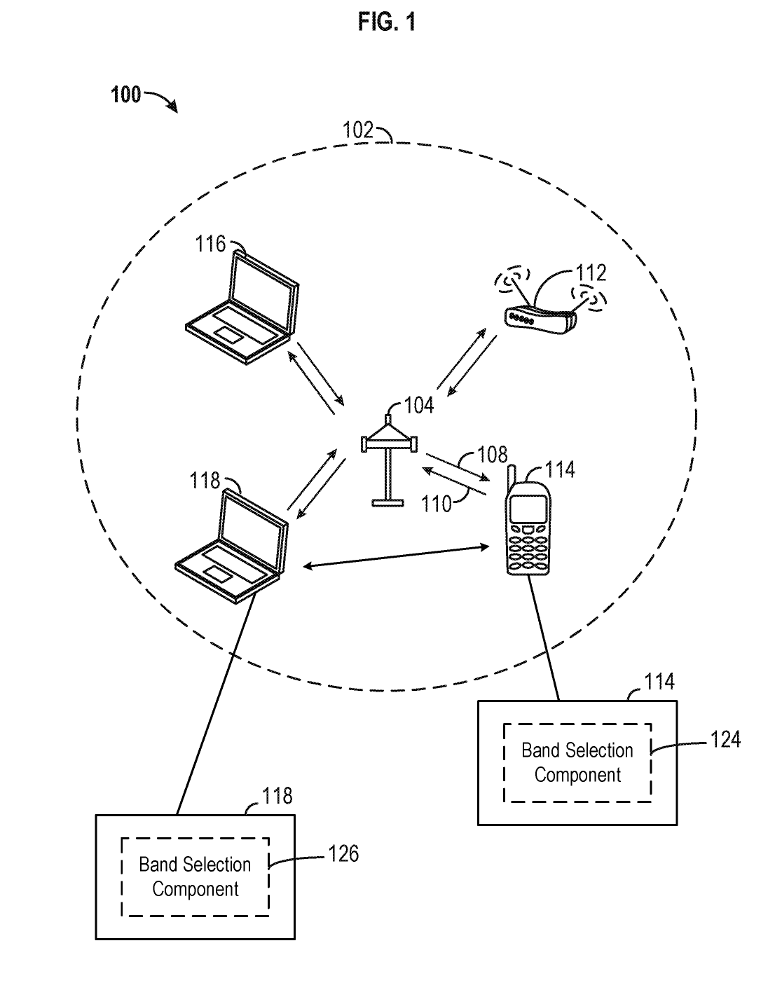

FIG. 1 shows an example wireless communication system 100 The wireless communication system 100 may operate pursuant to a wireless standard, for example the IEEE 802.11 standard. The wireless communication system 100 may include an AP 104, which communicates with STAs (such as STAs 112, 114, 116, and 118).

In some implementations, the wireless communication system 100 may include various devices, which are the components that access the wireless network. For example, there may be two types of devices: access points (APs) 104 and clients (also referred to as stations or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (such as the IEEE 802.11 protocol) compliant wireless link to obtain general connectivity to the Internet or to other wide area networks. In some implementations, a STA also may be used as an AP.

An AP also may include, be implemented as, or known as a NodeB, Radio Network Controller (RNC), eNodeB, Base Station Controller (BSC), Base Transceiver Station (BTS), Base Station (BS), Transceiver Function (TF), Radio Router, Radio Transceiver, connection point, or some other terminology.

A STA also may include, be implemented as, or known as an access terminal (AT), a subscriber station, a subscriber unit, a mobile station, a remote station, a remote terminal, a user terminal, a user agent, a user device, a user equipment, or some other terminology. In some implementations, a station may include a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (such as a cellular phone or smartphone), a computer (such as a laptop), a portable communication device, a headset, a portable computing device (such as a personal data assistant), an entertainment device (such as a music or video device, or a satellite radio), a gaming device or system, a global positioning system device, or any other suitable device that is configured to communicate via a wireless medium.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously without causing significant analog-to-digital conversion (ADC) clipping noise. The AP 104 may improve suppression of ACI, for example, by having separate finite impulse response (FIR) filters for each channel or having a longer ADC backoff period with increased bit widths.

The AP 104 may act as a base station and provide wireless communication coverage in a basic service area (BSA) 102. A BSA (such as the BSA 102) is the coverage area of an AP (such as the AP 104). The AP 104 along with the STAs associated with the AP 104 and that use the AP 104 for communication may be referred to as a basic service set (BSS). It should be noted that the wireless communication system 100 may not have a central AP (such as the AP 104), but rather may function as a peer-to-peer network between the STAs. Accordingly, the functions of the AP 104 described herein may alternatively be performed by one or more of the STAs.

The AP 104 may transmit on one or more channels (such as multiple narrowband channels, each channel including a frequency bandwidth) a beacon signal (or simply a “beacon”), via a communication link such as the downlink 108, to other nodes (STAs) of the wireless communication system 100, which may help the other nodes (STAs) to synchronize their timing with the AP 104, or which may provide other information or functionality. Such beacons may be transmitted periodically. In some aspects, the period between successive transmissions may be referred to as a superframe. Transmission of a beacon may be divided into a number of groups or intervals. In some aspects, the beacon may include, but is not limited to, such information as timestamp information to set a common clock, a peer-to-peer network identifier, a device identifier, capability information, a superframe duration, transmission direction information, reception direction information, a neighbor list, and an extended neighbor list, some of which are described in additional detail below. Thus, a beacon may include information that is both common (such as shared) amongst several devices and specific to a given device.

In some aspects, a STA (such as the STA 114) may associate with the AP 104 in order to send communications to and to receive communications from the AP 104. In some aspects, information for associating is included in a beacon broadcast by the AP 104. To receive such a beacon, the STA 114 may, for example, perform a broad coverage search over a coverage region. A search also may be performed by the STA 114 by sweeping a coverage region in a lighthouse fashion, for example. After receiving the information for associating, either from the beacon or probe response frames, the STA 114 may transmit a reference signal, such as an association probe or request, to the AP 104. In some aspects, the AP 104 may use backhaul services, for example, to communicate with a larger network, such as the Internet or a public switched telephone network (PSTN).

In some aspects, the STA 114 may include one or more components for enabling band selection with respect to a NAN service. For example, the STA 114 may include a band selection component 124. The STA 114 may be configured to provide a NAN service to another STA (such as the STA 118). In this configuration, the band selection component 124 may be configured to determine frequency band information for communicating over a NAN data link (NDL) associated with a NAN service and to provide the determined frequency band information for transmission to a subscriber of the NAN service for setting up the NDL.

In some other aspects, the STA 118 may include one or more components for performing band selection with respect to a NAN service. For example, the STA 118 may include a band selection component 126. The band selection component 126 may be configured to receive, from the STA 114, for example, a message that includes frequency band information for communicating over an NDL associated with a NAN service. The band selection component 126 may be configured to select a frequency band for communicating over the NDL based on the received frequency band information. The band selection component 126 may be configured to setup a connection with the STA 114 over the NDL based on the selected frequency band.

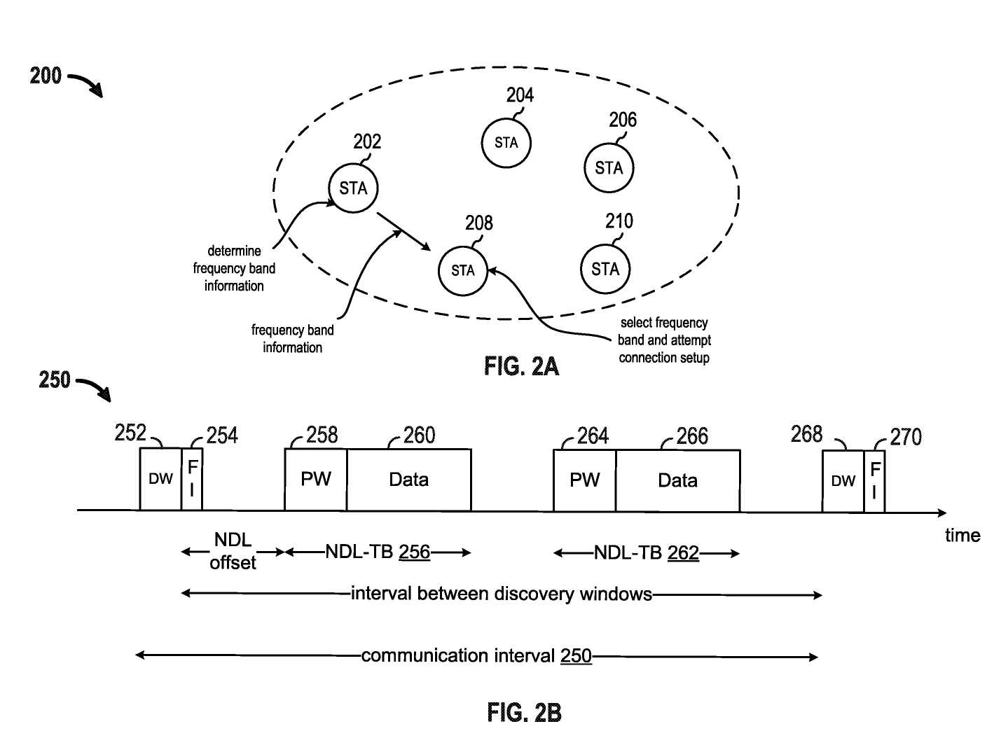

FIG. 2A is a diagram 200 of a NAN cluster. A NAN cluster (or NAN data cluster) may include multiple wireless devices, such as STAs 202, 204, 206, 208, and 210 (or the STAs 112, 114, 116, and 118). One or more NAN clusters may make up a NAN network. A NAN cluster may be a collection of NAN devices that share a common set of NAN parameters, which may include a time period between consecutive discovery windows, the time duration of the discovery windows, and a beacon interval. In some aspects, the STAs 202, 204, 206, 208, and 210 participating in the NAN cluster may be synchronized to the same NAN clock, which may be determined by the STA 202, for example, if the STA 202 is acting in the anchor master role of the NAN cluster. The STA 202, as the anchor master, may determine the timing synchronization function (TSF) and broadcast the TSF in the NAN synchronization beacon. Other STAs in the NAN cluster may adopt the TSF and broadcast the TSF to other devices within the NAN. The NAN synchronization beacon may be broadcast by NAN devices during the discovery window. NAN devices that receive the NAN synchronization beacon may use the beacon for clock synchronization. In some other aspects, each wireless device within the NAN cluster may communicate with another wireless device via a device-to-device (D2D) connection. For example, the STA 202 may communicate with the STA 208 via a D2D connection.

FIG. 2B is a diagram of a communication interval 250 in a NAN. The communication interval 250 may include discovery windows 252, 268 (such as NAN service discovery windows, which in some implementations, may have 16 time units or 16 ms), which may be time windows designated for and dedicated for enabling wireless devices (such as a STA) within a NAN to discover other peer wireless devices. That is, during the discovery window 252, for example, wireless devices in the NAN may transmit peer discovery signals, such as NAN service discovery frames, for peer discovery. The discovery window 252 may correspond to a time period and occur within a discovery channel on which the wireless devices in the NAN converge for peer discovery. In some implementations, the time interval between two discovery windows may be 512 time units (which may translate to 512 ms). The communication interval 250 may include fixed intervals 254 allocated for connection setup. For example, after wireless devices discover each other during the discovery window 252, the wireless devices may utilize the fixed interval 254 after the discovery window 252 to transmit signaling for a connection setup (such as a D2D connection setup). In some aspects, the fixed interval 254 may immediately follow the discovery window 252 and may be dedicated for connection setup. In some other aspects, the fixed interval 254 may follow the discovery window 252, but need not immediately follow the discovery window 252.

In some aspects, wireless devices may perform connection setup during the fixed intervals 254, 270. Wireless devices that publish or subscribe to a service may remain awake after the discovery windows 252, 268 to exchange connection setup messages in the fixed intervals 254, 270. In some other aspects, wireless devices may perform connection setup during a data link time block (DL-TB) (or another type of time block) in addition to during the fixed intervals 254, 270. As shown in FIG. 2B, the communication interval 250 may include one or more time blocks, such as a first NDL time block (NDL-TB) 256 and a second NDL-TB 262. Each NDL-TB may represent a set of time-frequency resources for wireless transmission and reception. The first NDL-TB 256 may be offset from the end or beginning of the discovery window 252 by an NDL offset value. The first NDL-TB 256 may include a first paging window 258 and a first data window 260. The first paging window 258 may be used by a first wireless device for paging a second wireless device to indicate that the first wireless device has data to transmit to the second wireless device (such as data related to a photo sharing service). Subsequently, the first wireless device may transmit the data in the first data window 260 used for transmitting data associated with destinations/wireless devices identified during the first paging window 258. Similarly, the second NDL-TB 262 may include a second paging window 264 and a second data window 266. In some other aspects, if the second wireless device is not paged during a paging window (such as no data is expected for the second wireless device), then the second wireless device may enter a sleep or doze state.

During connection setup, NAN devices may establish a schedule for communicating over an NDL. In some implementations, there may be one NDL between two NAN devices. A single NDL, however, may support multiple NAN data paths (NDPs) between the two NAN devices. Each NDP may be associated with a different service (such as a gaming service, a photo-sharing service, a video streaming service, etc.) or a different instance of the same service. In some aspects, each NDP may have its own quality of service and security requirements. In some other aspects, each NDP may have its own interface. As between the two NAN devices, the NDPs between the two NAN devices may conform to the same schedule, which may be the NDL schedule between the two STAs.

In some aspects, an NDL schedule may include a number of repeating NDL-TBs in between a number of repeating DWs. The number of NDL-TBs and DWs may be based on a lifetime of the NDL schedule. For example, the repeating NDL-TBs may be on a same channel within a frequency band (such as channel X of the 2.4 gigahertz (GHz) band). In some implementations, the NDL-TBs may be from different channels within a same frequency band (such as channel X, Y, and Z of the 2.4 GHz band). In some other implementations, the NDL-TBs may be from different channels on different frequency bands (such as channel X and Y of the 2.4 GHz band and channel Z of the 5 GHz band).

A NAN network provides a mechanism for wireless devices to synchronize time and channel on which the devices may converge to facilitate the discovery of NAN services that have been made discoverable on existing or new devices that enter the NAN. In some aspects, the service discovery may occur without the assistance of an AP. A NAN network may operate in one or more channels of one or more frequency bands (such as the sub-1 GHz band, 2.4 GHz band, the 5 GHz band, and the 60 GHz band). For example, the NAN network may operate on channel 6 (2.437 GHz) in the 2.4 GHz band and optionally in channel 44 (5.220 GHz) or channel 149 (5.745 GHz) of the 5 GHz band. Further, the NDL may operate in one or more channels of one or more frequency bands (such as including the sub-1 GHz band, 2.4 GHz band, the 5 GHz band, and the 60 GHz band).

NAN communications, including both discovery and data link communications, may occur on any frequency band. For example, NAN communications may occur in the sub-1 GHz band, the 2.4 GHz band, the 5 GHz band, the 60 GHz band, or some other frequency band. High frequency bands, such as the 60 GHz band, may be able to support high data throughput but are limited by a shorter communication range as compared to lower frequency bands (such as the 2.4 GHz band). Wireless devices that are able to communicate at the 2.4 GHz band may not be able to communicate at the 60 GHz band due to the reduced coverage range at the higher bands. Therefore, a 60 GHz band has a smaller potential coverage range than a 5 GHz band, which has a smaller potential coverage range than a 2.4 GHz band, which has a smaller potential coverage range than a sub-1 GHz band.

Referring to FIG. 2A, the STA 202 may be a publisher of a NAN service (such as a file sharing or gaming service) or a provider of the NAN service (such as a proxy device for the publisher of the NAN service). That is, the STA 202 may provide or publish the NAN service to other STAs interested in the NAN service. Traffic associated with the NAN service may be transmitted over an NDL associated with the NAN service. In some implementations, as the publisher of the NAN service, the STA 202 may determine frequency band information for establishing the NDL for the NAN service. In some aspects, the STA 202 may determine the frequency band information based on a capability of the STA 202, a type of service, and network conditions. The STA 202 may identify frequency bands on which the STA 202 may communicate and select one or more of the frequency bands for communication. The STA 202 may determine the type of service being offered. For services that may require higher throughput, such as a video streaming services, the STA 202 may choose higher frequency bands available for the service (such as the 60 GHz band). Also, the STA 202 may detect network conditions at one or more channels within the various frequency bands. If certain frequency bands are more congested (such as more traffic or greater amount of interference), the STA 202 may select frequency bands, including one or more channels within the frequency bands, with less congestion. In some aspects, the frequency band information may explicitly indicate one or more frequency bands (such as the 2.4 GHz and 5 GHz bands). In some other aspects, the frequency band information may indicate one or more channels that implicitly indicate the different frequency bands preferred for NDL communication. For example, channel 6 has a center frequency at 2.437 GHz frequency and is associated with the 2.4 GHz band. Channel 36 has a frequency of 5.180 GHz and is associated with the 5 GHz band. An indication of channels 6 and 36 for NAN communication implies communication on the 2.4 and 5 GHz bands.

After determining the channels or the preferred frequency bands for setting up the NDL of the NAN service, the STA 202 may indicate the one or more preferred frequency bands in a publish message (or another type of message). In some other aspects, the STA 202 may indicate one or more channels in one or more preferred frequency bands in the publish message. The publish message may be a message announcing or publishing the availability of the NAN service. The publish message may be broadcast like a beacon message during a discovery window, for example, or during another window or time period. In some implementations, the publish message may be transmitted in response to a device interested in subscribing to the NAN service (such as a subscriber or subscriber device). For example, the subscriber device may transmit a service discovery message that indicates a request for a particular NAN service. Upon receiving the service discovery message, the publisher device may broadcast the publish message indicating an availability of the requested NAN service at one or more frequency bands. In some implementations, the publish message may be unsolicited. That is, the publisher device may periodically broadcast a publish message without receiving a service discovery message from a potential subscriber.

In some aspects, the frequency band information may include one or more times when the STA 202 is available for connection setup at the respective channels or bands or when the STA 202 is available for communicating on the channels or bands after connection setup. For example, the frequency band information may indicate that the STA 202 is available on one or more time blocks (such as NDL-TBs) for connection setup and subsequently available for sending or receiving traffic over the NDL after connection setup.

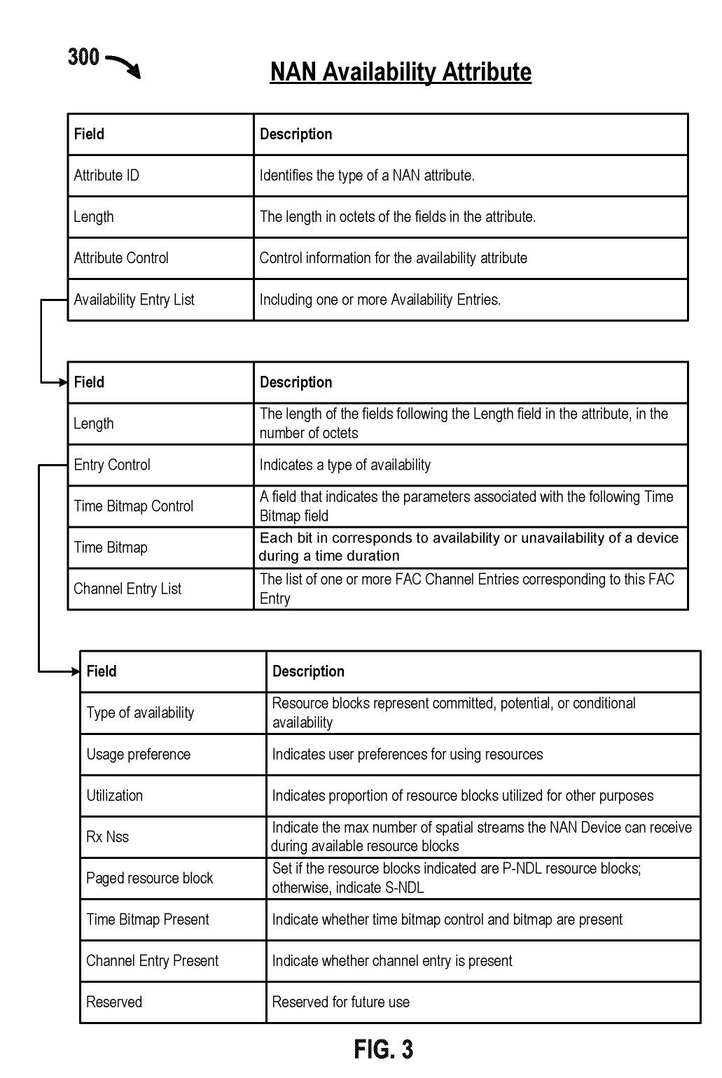

In some implementations, the frequency band information may be indicated via a usage preference sub-field of an entry control field in an availability attribute that may be included within the publish message. For example, the usage preference sub-field may indicate the ranking for one or more bands among other possible bands for connection setup. The availability attribute may indicate a NAN device's potential, proposed, or committed time and channel availability. FIG. 3 illustrates a diagram of a NAN availability attribute 300. As shown in FIG. 3, the NAN availability attribute 300 may include an attribute identifier (ID) field, a length field, an attribute control field, and an availability entry list. The attribute ID field may indicate that the attribute is a NAN availability attribute that indicates the availability of a STA transmitting the attribute. The length field may indicate the length of the attribute, the attribute control field may include control information regarding the attribute, and the availability entry list may include availability information regarding the STA. For example, the availability entry list may indicate times or resources for when the STA is available.

The availability entry list may include a length field, indicating the length of the availability entry list field, an entry control field that indicates a type of availability of the STA, a time bitmap control field that indicates parameters associated with the time bitmap field, a time bitmap field that corresponds to the availability or unavailability of the STA during one or more time durations, and a channel entry list that provides one or more FAC channel entries. The entry control field may include a type of availability field, a usage preference field, a utilization field, Rx NSS field, a paged resource block field, a time bitmap present field, a channel entry present field, and a reserved field. The type of availability field may indicate whether the resource blocks indicated by the STA refer to committed, potential, or conditional availability resource blocks. The usage preference field may be used to transmit the frequency band information as previously described. In some aspects, other fields or subfields within the NAN availability attribute also may be used to transmit the frequency band information. The utilization field may indicate a proportion of blocks utilized for other purposes, the Rx NSS field may indicate the number of spatial streams that the STA can receive during the available resource blocks, the paged resource block field may indicate whether the resource blocks are paged resource blocks, the time bitmap present field indicates whether the time bitmap control and bitmap files are present, and the channel entry present field indicates whether the channel entry field is present.

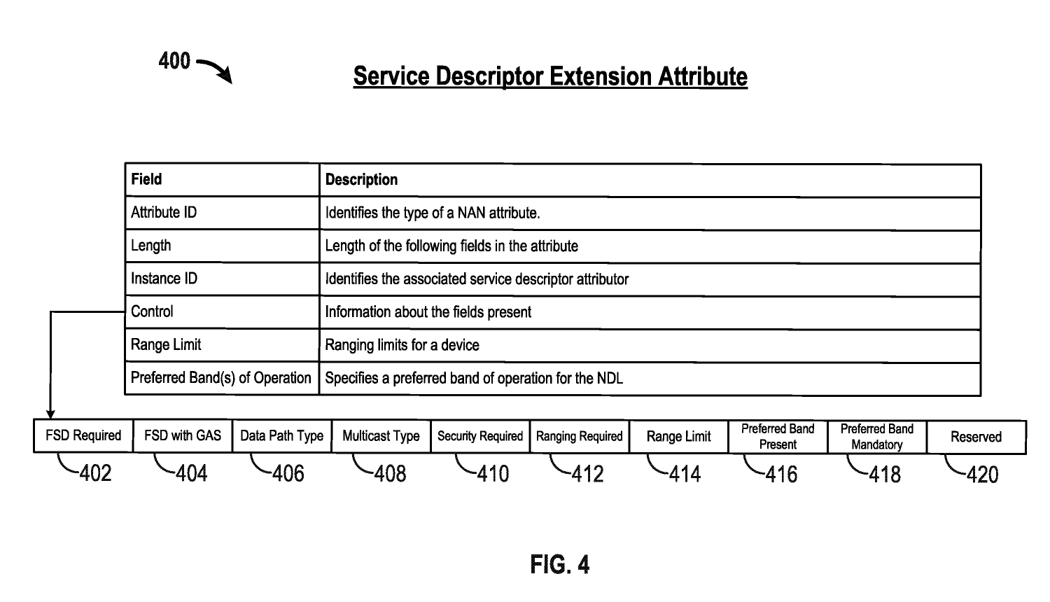

In some other implementations, instead of providing the frequency band information within an existing attribute, the frequency band information may be provided within a new attribute. FIG. 4 illustrates a service descriptor extension attribute 400. The service descriptor extension attribute 400 may include one or more of an attribute ID field, a length field, an instance ID field, a control field, a range limit field, and a preferred band(s) of operation field. The attribute ID field may be 1 octet in length and identify the attribute as a service descriptor extension attribute. The length field may be of 2 octets in length, of variable value, and may indicate the length of the fields following the length field in the service descriptor extension attribute 400. The instance ID field may be of 1 octet in length and identify the associated service descriptor attribute associated with the service descriptor extension attribute 400. The control field may be 2 octets in length and may include additional information about the fields present in the service descriptor extension attribute 400. The range limit field may be 4 octets in length and may indicate a range limit of the device. The range limit field may include an inner range limit subfield (such as 2 octets) and an outer range limit subfield (such as 2 octets). The inner range limit subfield may indicate a minimum required distance between the device and another device with which the device is to communicate and the out range limit subfield may indicate a maximum distance with which the device may communicate with another device. The preferred band of operation field may indicate one or more channels or one or more frequency bands at which the transmitting device is available for NDL connection setup. In some aspects, the field also may indicate one or more times during which the device is available for connection setup or for communicating traffic on the indicated one or more channels or frequency bands associated with the service after NDL connection setup. The channels for connection setup and for communication traffic may be different.

Referring to the service descriptor extension attribute 400, the control field may include an FSD required subfield 402, FSD with GAS subfield 404, data path type subfield 406, multicast type subfield 408, security required subfield 410, ranging required subfield 412, range limit subfield 414, preferred band present subfield 416, preferred band mandatory subfield 418, and a reserved subfield 420. In some aspects, each of the subfields, except for the reserved subfield 420, within the control field may be a bit indicator. For example, the FSD required subfield 402 may be set to 1 if further service discovery is required for the NAN service and set to 0 otherwise. The FSD with GAS subfield 404 may be set to 1 if generic advertisement service is used for further service discovery; otherwise, this subfield may be set to 0 if follow up is used for further service discovery. This subfield is valid if FSD required is set to 1, otherwise, this subfield may be reserved for other purposes. Data path type subfield 406 is set to 0 for unicast communication and 1 for multicast communication. Multicast type subfield 408 is set to 0 for one-to-many services and set to 1 for many-to-many services. This subfield may be valid if the data path type subfield is set to 1 and may be reserved otherwise. The security required subfield 410 may be set to 1 if security is required for the NDP or the NAN multicast service group (NMSG) associated with the NAN service; otherwise, this subfield may be set to 0. The ranging required subfield 412 may be set to 1 if ranging is required prior to subscription for the NAN service or set to 0 otherwise. The range limit subfield 414 may be set to 1 is the range limit is specific for the service or set to 0 otherwise. This subfield may be valid if ranging required is set to 1. The preferred band present subfield 416 may be set to 1 if the preferred band or channel is specified; otherwise, this subfield may be set to 0. The preferred band mandatory subfield 418 may be set to 1 if the specified preferred band is mandatory; otherwise, this subfield may be set to 0.

Although FIGS. 3 and 4 include multiple fields and subfields within the NAN availability attribute and the service descriptor extension attribute, the fields and subfields provided are optional. As such, a subset of the fields or subfields may be present in the NAN availability attribute and the service description extension attribute.

After the frequency band information is transmitted, different schemes, techniques, or methods may be utilized by STAs for purposes of performing band selection. The following three schemes are provided.

Scheme 1—NDL Connection Setup on Preferred Bands

In scheme 1, after a subscriber device, such as the STA 208, receives the publish message (or another type of message with the frequency band information) from a publisher device, such as the STA 202, via a NAN discovery channel. The STA 208 may select a frequency band or a channel within the frequency band for setting up an NDL with the STA 202 based on the received frequency band information. In some aspects, the STA 208 may select the channel or frequency band further based on the capabilities of the STA 208 or network conditions. For example, if the frequency band information includes channels on the 5 GHz band and the 60 GHz band, but the STA 208 does not support 60 GHz band transmissions, then the STA 208 may select the 5 GHz band for connection setup. In another example, if the STA 208 detects that channels on the 5 GHz band is congested, then the STA 208 may select a channel from the 60 GHz band. In some other aspects, the NDL may include multiple channels from the same or different frequency bands, and therefore, connection setup may occur over a single channel, multiple channels with the same frequency band, or multiple channels over multiple frequency bands. In some other aspects, the STA 208 may attempt connection setup at one or more periods indicated by the STA 202 in the received frequency band information. In some other aspects, the connection setup for the NDL may occur on the same or different channel and frequency band than the NAN discovery channel associated with the discovery window.

In some other aspects, the STA 208 may attempt to communicate with the STA 202 by attempting to associate with the STA 202. The STA 208 may transmit an association request to the STA 202 at the selected frequency band at an indicated time. The STA 208 may determine whether an association response, for example, is received from the STA 202. If an association response is received, then the STA 208 may determine that the STA 202 is available for communication over the selected frequency band. Otherwise, the STA 208 may determine that the STA 202 is unavailable for communication over the selected frequency band. If the STA 208 is unable to find the STA 202, the STA 208 may attempt connection setup on a different channel within the same frequency band or a different frequency band altogether as indicated by the frequency band information. If the different channel or different frequency band is associated with a period during which the STA 202 is available for connection setup, then the STA 208 may attempt connection setup at the indicated period.

If, however, the STA 208 is unable to connect with the STA 202 on any of the preferred channels or bands as indicated in the frequency band information, then the STA 208, in some aspects, may transmit a failure report to the STA 202 indicating that the STA 208 is unable to perform connection setup with the STA 202 based on the frequency band information. The failure report may be transmitted on a previously known channel that supported communication between the STA 202 and the STA 208. In some other aspects, the STA 208 may select another channel or frequency band that is not preferred by the STA 202 or not indicated by the frequency band information. The STA 208 may attempt connection setup over the other channel or frequency band. If the connection setup fails, then the STA 208 may transmit a failure report that indicates a failure to perform connection setup at one or more preferred channels or frequency bands and at one or more non-preferred channels or frequency bands. In some aspects, the failure report also may indicate a time at which connection setup was attempted. The failure report may be transmitted on a channel or frequency band on which the STA 202 and the STA 208 previously communicated.

Scheme 2—NDL Connection Setup on Preferred and Available Bands

Scheme 2 may be a band selection scheme that complements scheme 1, or may be utilized as an alternative to (or independent of) scheme 1. In scheme 2, if the STA 208 (the subscriber device) attempts connection setup on a frequency band or channel other than on a preferred frequency band or channel indicated in the frequency band information, then the STA 202 (the publisher device) may assess the link quality and channel conditions to determine if the STA 208 is close enough to have a successful connection on the preferred channel or the preferred frequency band.

The STA 202 may determine the link quality based on a link matrix, a received signal strength indication (RSSI), or other channel quality metrics. For example, based on an association request from the STA 208, the STA 202 may determine an RSSI of the received association request. If the RSSI is below a threshold, then the STA 202 may determine that a higher frequency band may not be supported due to the distance between the STAs, and the STA 202 may proceed with connection setup with the STA 208 on the current channel or frequency band (such as 2.4 GHz band) even if the current channel or frequency band is not preferred. However, if the RSSI is above a threshold, then the STAs 202, 208 may be sufficiently close in proximity to support a higher frequency band (such as the 5 GHz band or 60 GHz band), which may be preferred by the STA 202. In another example, the STA 202 may determine the link quality based on an exchange of null data packets that may include training symbols. The training symbols may be used by the STA 202 to estimate the channel between the STA 202 and the STA 208. If channel conditions are not above a threshold that would indicate support for a higher frequency band, then the STA 202 may accept the connection setup, but if the channel conditions are above the threshold, then the STA 202 may reject the connection setup and instruct the STA 208 to attempt connection setup on a preferred frequency band, which may be a higher frequency band than the current frequency band. For example, if the channel conditions are good enough to support a higher frequency band, then the STA 202 may reject the connection setup at the lower frequency band and request connection setup at the preferred frequency band, which may be a higher frequency band than the frequency band on which connection setup was attempted. But if the channel conditions are average or poor at the current frequency band on which connection setup is attempted, then the STA 202 may not request connection setup on a higher frequency band because the STAs 202, 208 may already be too far apart.

If the STA 202 determines the NDL may support a preferred frequency band (or channel) even though the STA 208 did not attempt connection setup on the frequency band (or channel), then the STA 202 may determine to reject the connection setup with the STA 208. The STA 202 may transmit a failure report (or some other indication) that the STA 208 is to retry connection setup on one of the preferred frequency bands indicated in the previously transmitted frequency band information. In some aspects, the failure report may include updated times at which the STA 202 may be available on the channels or frequency bands indicated in the frequency band information.

If connection setup fails, and the STA 208 receives the failure report from the STA 202, then the STA 208 may attempt connection setup on one or more of the preferred channels or frequency bands as indicated in the received frequency band information.

In some implementations, having determined the link quality during connection setup, the STA 202 may transmit a link quality report to the STA 208. In some aspects, the link quality report may indicate (such as via a bit indicator) whether the NDL may support a data rate or modulation and coding scheme (MCS). In some other aspects, the link quality report may include antenna feedback information based on a millimeter wave beam selection protocol. In some implementations, the STA 208 may have transmitted the association request to the STA using a beamforming technique. The association request may be transmitted over multiple antennas at the STA 208. In the link quality report, the STA 202 may indicate one or more antennas at the STA 208 for which the signal strength was the dominant compared to other antennas at the STA 208.

As previously discussed, scheme 2 may be utilized in addition to, or instead of, scheme 1. If scheme 2 is utilized in addition to scheme 1, then scheme 1 may first be used to attempt connection setup. For example, the STA 208 may attempt connection setup using a channel or frequency band indicated in the frequency band information. If the connection setup fails, then the STA 208 may attempt connection setup using a channel or frequency band that is not preferred by the STA 202. For example, the STA 202, upon detecting connection setup on a non-preferred channel may measure the link quality or channel conditions on the non-preferred channel. In another example, the STA 202, upon detecting connection setup on a non-preferred frequency band may measure the link quality or channel conditions on the non-preferred frequency band. If the link quality is not above a threshold, indicating that a connection on a higher frequency band would not be supported), then the STA 202 may continue with connection setup because the STAs 202, 208 may not be close enough to attempt connection setup on a higher frequency band. By contrast, if the link quality is above a threshold, then the STA 202 may reject the connection setup because the STAs 202, 208 may be close enough to be able to support an NDL over a higher frequency band. If scheme 2 is utilized as an alternative to scheme 1, then after STA 202 transmits the frequency band information, the STA 208 may attempt connection setup. If the STA 208 attempts connection setup on a non-preferred band, then the STA 202 may determine whether to reject connection setup based on the link quality at the non-preferred frequency band.

Scheme 3—NDL Connection Setup with Link Quality Assessments

In scheme 3, after the STA 208 receives the publish message from the STA 202, the STA 208 may select a channel or frequency band based on the frequency band information in the publish message for setting up an NDL connection with the STA 202. The STA 208 may transmit messages to the STA 202 on the selected channel or the selected frequency band to assess link conditions. In some aspects, if the frequency band information indicated periods reserved for connection setup, then the STA 208 may transmit the frames at the selected channel or frequency band at the indicated time(s). The frames may include quality of service (QoS) null frames, NDPs, or directional multi-gain (DMG) beam training frames (in a 60 GHz band).

Upon receiving the frames, the STA 202 may provide feedback information to the STA 208. In some aspects, if DMG beam training frames are transmitted, then the STA 202 may transmit a frame that indicates one or more antennas at the STA 208 for optimum beam forming transmissions. In some other aspects, if QoS null frames are transmitted, then the STA 202 may provide RSSI information to the STA 208 based on the received QoS frames. Based on the feedback information, the STA 208 may determine the channel or link quality between the STAs 202, 208. If the channel conditions or link quality is above a threshold, then the STA 208 may establish the link (such as perform NDL connection setup) with the STA 202 based on the selected and preferred channel or frequency band. However, if the STA 208 is unable to communicate with the STA 202 or the link quality or channel quality is below a threshold, then the STA 202 may determine to attempt connection setup on a different channel or frequency band. The different channel or frequency band may be a different channel or frequency band indicated by the frequency band information or a non-preferred channel or frequency band not indicated by the frequency band information. When attempting NDL connection setup on the different channel or frequency band, the STA 208 may provide a link quality report to the STA 202. The link quality report may be based on the previously determined link quality. For example, the link quality report may be based on the transmitted QoS null frames, NDPs, DMG beam training frames, or other frames. The link quality report may indicate that at least one channel or frequency band indicated in the frequency band information is below a threshold and that connection setup for the NDL is to be attempted on a different channel or frequency band. The STA 208 may attempt connection setup on the different channel or frequency band. If the connection setup is successful, then the NDL connection may be established for the different channel or frequency band.

In some implementations, for any of the schemes, both the publisher device and the subscriber device may provide an indication of connection setup failure if connection setup failure is detected. For example, the STA 202 may provide a connection failure report to the STA 208 if the STA 202 detects connection failure and vice versa. The connection failure report may include a reason or reason code for failure that may enable the receiving device to attempt connection setup with different parameters or to abandon connection setup. After the connection failure report is transmitted, either the transmitting device or the receiving device may determine to negotiate a connection setup procedure with a preference for a different channel or frequency band.

In some other aspects, the publisher and the subscriber device may use any of the schemes in any combination. For example, the devices may combine schemes 1 and 2, schemes 1 and 3, or schemes 2 and 3.

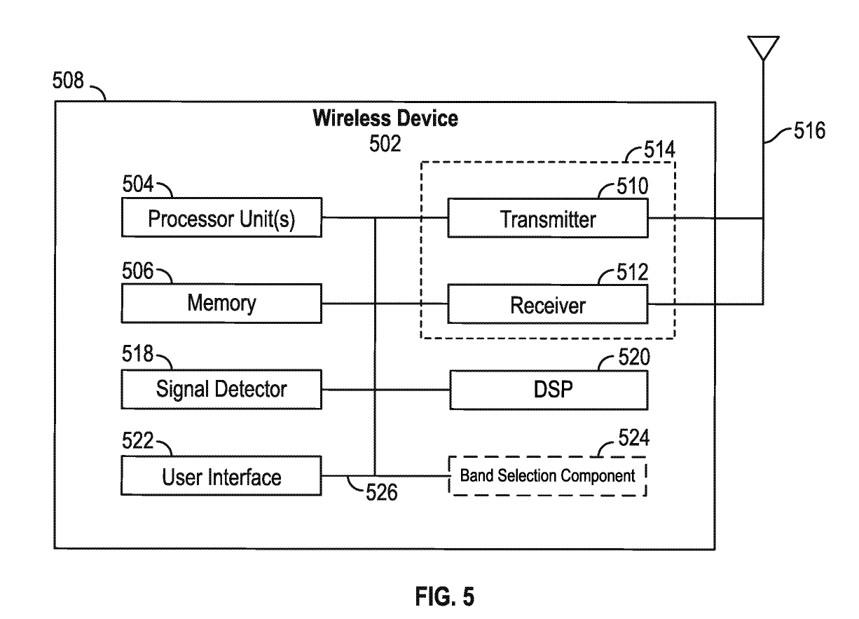

FIG. 5 shows an example functional block diagram of a wireless device 502 that may provide information for band selection and perform band selection within the wireless communication system 100 of FIG. 1. The wireless device 502 is an example of a device that may be configured to implement the various methods described herein. For example, the wireless device 502 may include one of the STAs 114, 118, 202, 204, 206, 208, and 210.

The wireless device 502 may include a processor 504, which controls operation of the wireless device 502. The processor 504 also may be referred to as a central processing unit (CPU). Memory 506, which may include both read-only memory (ROM) and random access memory (RAM), may provide instructions and data to the processor 504. A portion of the memory 506 also may include non-volatile random access memory (NVRAM). The processor 504 typically performs logical and arithmetic operations based on program instructions stored within the memory 506. The instructions in the memory 506 may be executable (by the processor 504, for example) to implement the methods described herein.

The processor 504 may include or be a component of a processing system implemented with one or more processors. The one or more processors may be implemented with any combination of general-purpose microprocessors, microcontrollers, DSPs, FPGAs, PLDs, controllers, state machines, gated logic, discrete hardware components, dedicated hardware finite state machines, or any other suitable entities that can perform calculations or other manipulations of information.

The processing system may include an interface configured to provide information for transmission by the transmitter 510 or the transceiver 514. The interface also may be configured to receive information from the receiver 512 or the transceiver 514. In some aspects, the interface may be an interface of the processor 504.

The processing system also may include machine-readable media for storing software. Software shall be construed broadly to mean any type of instructions, whether referred to as software, firmware, middleware, microcode, hardware description language, or otherwise. Instructions may include code (such as in source code format, binary code format, executable code format, or any other suitable format of code). The instructions, when executed by the one or more processors, cause the processing system to perform the various functions described herein.

The wireless device 502 also may include a housing 508, and the wireless device 502 that may include a transmitter 510 or a receiver 512 to allow transmission and reception of data between the wireless device 502 and a remote device. The transmitter 510 and the receiver 512 may be combined into a transceiver 514. An antenna 516 may be attached to the housing 508 and electrically coupled to the transceiver 514. The wireless device 502 also may include multiple transmitters, multiple receivers, multiple transceivers, or multiple antennas.

The wireless device 502 also may include a signal detector 518 that may be used to detect and quantify the level of signals received by the transceiver 514 or the receiver 512. The signal detector 518 may detect such signals as total energy, energy per subcarrier per symbol, power spectral density, and other signals. The wireless device 502 also may include a DSP 520 for use in processing signals. The DSP 520 may be configured to generate a packet for transmission. In some aspects, the packet may include a physical layer convergence procedure (PLCP) protocol data unit (PPDU).

The wireless device 502 may further include a user interface 522 in some aspects. The user interface 522 may include a keypad, a microphone, a speaker, or a display. The user interface 522 may include any element or component that conveys information to a user of the wireless device 502 or receives input from the user.

When the wireless device 502 is implemented as a STA (such as the STA 114), the wireless device 502 also may include a band selection component 524. In some implementations, the band selection component 524 may be configured to determine frequency band information for communicating over an NDL associated with a NAN service. The band selection component 524 may be configured to provide the determined frequency band information for transmission to a subscriber of the NAN service for setting up the NDL. In some aspects, the determined frequency band information may be transmitted in a publish message. In some other aspects, the transmission of the publish message may be unsolicited. In some other aspects, the band selection component 524 may be configured to receive a service discovery message from the subscriber. The determined frequency band information may be transmitted in response to the received service discovery message.

In some other aspects, the determined frequency band may be indicated in a usage preference subfield of an entry control field within an availability entry attribute that is included within the publish message. For example, the usage preference sub-field may indicate the ranking for one or more bands among other possible bands for connection setup. In some other aspects, the band selection component 524 may be configured to provide one or more periods indicating when the wireless device 502 is available for connection setup based on the determined frequency band information. In some other aspects, the band selection component 524 may be configured to perform connection setup with the subscriber of the NAN service. In some other aspects, the connection setup for the NDL may be successful on a frequency band indicated in the frequency band information. In this aspect, the NDL may be established on the frequency band, and the frequency band may be different from a second frequency band on which the frequency band information was transmitted.

In some other aspects, the band selection component 524 may be configured to perform connection setup by determining that the subscriber is attempting to setup the NDL on a first frequency band that is different from a second frequency band indicated by the frequency band information, by determining a link quality associated with a link over the first frequency band, and by determining whether to reject the connection setup based on the determined link quality associated with the first frequency band. In some other aspects, the band selection component 524 may be configured to perform connection setup by providing an indication, based on the determination to reject the connection setup, that the subscriber is to retry connection setup on one of the frequency bands indicated in the frequency band information. In some other aspects, the band selection component 524 may be configured to perform connection setup by determining a link quality associated with a link over a frequency band. In this aspect, the link quality is determined based on an exchange of null data packets that include channel training symbols. In this aspect, the band selection component 524 may be further configured to provide a link quality report based on the determined link quality. The link quality report may indicate at least one of an indication of whether the link supports a data rate or antenna feedback information based on a millimeter wave beam selection protocol.

In some other aspects, the band selection component 524 may be configured to receive a link quality report. In some other aspects, the link quality report may indicate that a link quality of a connection associated with at least one frequency band included in the frequency band information is below a threshold and that connection setup for the NDL is to be attempted on a different frequency band. In some other aspects, the connection setup for the NDL may be successful on the different frequency band, and the NDL may be established on the different frequency band. In some other aspects, the band selection component 524 may be configured to provide an indication of connection setup failure if connection setup failure is detected, and the indication may include a reason code for the connection setup failure. In some other aspects, the determined frequency band information may be transmitted in a service descriptor extension attribute.

In some other implementations the band selection component 524 may be configured to receive, from a second apparatus, a message that includes frequency band information for communicating over an NDL associated with a NAN service. The band selection component 524 may be configured to select a frequency band for communicating over the NDL based on the received frequency band information. The band selection component 524 may be configured to attempt to setup a connection with the second apparatus over the NDL based on the selected frequency band. In some aspects, the band selection component 524 may be configured to attempt to setup the connection by determining whether the second apparatus is available for connection setup over the selected frequency band, by selecting a different frequency band from the frequency band information if the second apparatus is unreachable on the selected frequency band, and by attempting to setup the connection with the second apparatus based on the selected different frequency band. In some other aspects, the band selection component 524 may be further configured to attempt to setup the connection by selecting another frequency band that is different from any frequency band indicated by the frequency band information and by attempting to setup the connection with the second apparatus based on the selected other frequency band.

In some other aspects, the band selection component 524 may be further configured to provide a second message to the second apparatus indicating the attempt to setup the connection with the second apparatus based on the received frequency band information was unsuccessful. In some other aspects, the band selection component 524 may be further configured to receive one or more periods (such as at a particular time, within a particular range of time, etc.) indicating when the second apparatus is available for connection setup on the received frequency band information. The band selection component 524 may attempt to communicate with the second apparatus based on the received one or more periods. In some other aspects, the band selection component 524 may be further configured to receive a message rejecting a connection setup with the second apparatus. The message may indicate that the wireless device 502 is to retry connection setup on one of the frequency bands indicated in the received frequency band information. In some other aspects, the band selection component 524 may be configured to attempt to setup the connection by determining if the wireless device 502 is able to communicate with the second apparatus on the selected frequency band and by determining a link quality with the second apparatus based on the selected frequency band if the wireless device 502 is able to communicate with the second apparatus on the selected frequency. In some other aspects, the band selection component 524 may be further configured to attempt to setup the connection by selecting a different frequency band based on the determined link quality and by providing a link quality report to the second apparatus based on the determined link quality. In some other aspects, the link quality may be determined based on QoS null frames, NDPs, or directional multi-gain beam training frames, or other frames.

In some other aspects, the band selection component 524 may be further configured to provide a link quality report based on the determined link quality. The link quality report may indicate at least one of an indication of whether the link supports a data rate or antenna feedback information based on a millimeter wave beam selection protocol. In some other aspects, the band selection component 524 may be further configured to provide an indication of connection setup failure if connection setup failure is detected. The indication may include a reason code for the connection setup failure. In some other aspects, the indication of connection setup failure may be transmitted on a channel previously used for communication between the wireless device 502 and the second apparatus. In some other aspects, the indication of connection setup failure may be transmitted during a discovery window of the NAN.

The various components of the wireless device 502 may be coupled together by a bus system 526. The bus system 526 may include a data bus, for example, as well as a power bus, a control signal bus, and a status signal bus in addition to the data bus. Components of the wireless device 502 may be coupled together or accept or provide inputs to each other using some other mechanism.

Although a number of separate components are illustrated in FIG. 5, one or more of the components may be combined or commonly implemented. For example, the processor 504 may be used to implement not only the functionality described above with respect to the processor 504, but also to implement the functionality described above with respect to the signal detector 518, the DSP 520, the user interface 522, or the band selection component 524. Further, each of the components illustrated in FIG. 5 may be implemented using a plurality of separate elements.

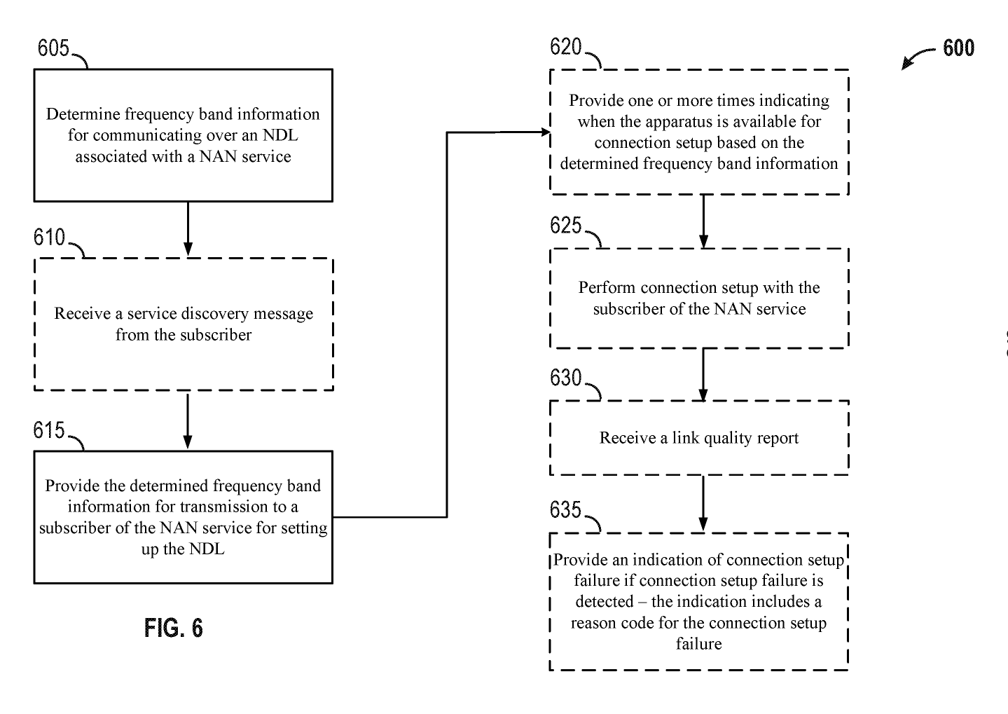

FIG. 6 is a flowchart of a method 600 for enabling band selection. The method 600 may be performed using an apparatus, such as a publisher device (such as the STAs 114, 118, the STAs 202, 204, 206, 208, and 210, for example). Although the method 600 is described below with respect to the elements of wireless device 502 of FIG. 5, below, other components may be used to implement one or more of the functions described herein.

At block 605, the apparatus may determine frequency band information for communicating over an NDL associated with a NAN service. The apparatus may determine the frequency band information by determining one or more frequency bands in which the apparatus is capable of communicating. In some aspects, the one or more frequency bands may further be determined based on an amount of traffic detected on the frequency bands. The apparatus may determine not to use certain frequency bands with large amounts of traffic. In some other aspects, the frequency band information may further include one or more times at which the apparatus is available for communication on each of the one or more frequency bands. For example, referring to FIG. 2A, the STA 202 may determine frequency band information for communication over an NDL associated with a NAN service.

At block 610, the apparatus may receive a service discovery message from a subscriber. For example, referring to FIG. 2A, the STA 202 may receive a service discovery message from the STA 208 (the subscriber).

At block 615, the apparatus may provide the determined frequency band information for transmission to a subscriber of the NAN service for setting up the NDL. For example, referring to FIG. 2A, the STA 202 may provide the determined frequency band information for transmission to the STA 808 for setting up the NDL. In some aspects, the STA 202 may provide the determined frequency band information by transmitting the frequency band information to the STA 208.

At block 620, the apparatus may provide one or more periods indicating when the apparatus is available for connection setup based on the determined frequency band information. For example, the STA 202 may transmit one or more periods indicating when the STA 202 is available for connection setup. The one or more times may be transmitted within the frequency band information or in a separate message.

At block 625, the apparatus may perform connection setup with the subscriber of the NAN service. For example, referring to FIG. 2A, the STA 202 may perform connection setup with the STA 208. In some aspects, the STA 202 may perform connection setup on a frequency band that is indicated within the frequency band information and the frequency band may be a different frequency band than the frequency band on which the frequency band information was transmitted. The STA 202 may perform connection setup by determining that the STA 208 is attempting to setup the NDL on a frequency band within the frequency band information and by accepting the connection setup request.

At block 630, the apparatus may receive a link quality report. For example, referring to FIG. 2A, the STA 202 may receive a link quality report from the STA 208.

At block 635, the apparatus may provide an indication of connection setup failure if connection setup failure is detected. The indication may include a reason code for the connection setup failure. For example, referring to FIG. 2A, the STA 202 may provide an indication of connection setup failure if the connection setup between the STA 202 and the STA 208 has failed.

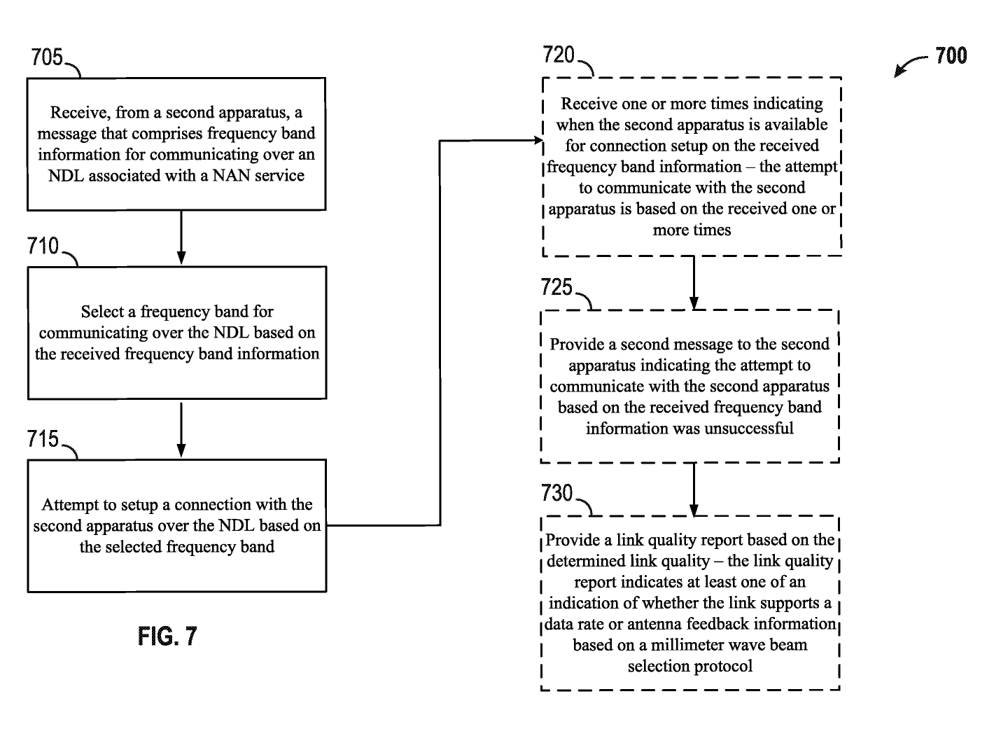

FIG. 7 is a flowchart of a method 700 for performing band selection. The method 700 may be performed using an apparatus, such as a subscriber device (such as the STAs 114, 118, the STAs 202, 204, 206, 208, and 210, for example). Although the method 700 is described below with respect to the elements of wireless device 502 of FIG. 5, below, other components may be used to implement one or more of the functions described herein.

At block 705, the apparatus may receive, from a second apparatus, a message that includes frequency band information for communicating over an NDL associated with a NAN service. For example, referring to FIG. 2A, the apparatus may be the STA 208. The STA 208 may receive, from the STA 202 (the second apparatus), a message that includes frequency band information for communicating over an NDL associated with a NAN service. The message may be a publish message.

At block 710, the apparatus may select a frequency band for communicating over the NDL based on the received frequency band information. For example, referring to FIG. 2A, the apparatus may be the STA 208, and the STA 208 may select a frequency band for communicating over the NDL based on the received frequency band information. The STA 208 may selectin the frequency band by determining whether the STA 208 is capable of communicating on any frequency bands included in the frequency band information. The STA 208 may determine a channel quality or traffic level on the frequency bands on which the STA 208 is capable of communicating and that has been indicated by the STA 202 and select the frequency band that has the least traffic or the best channel quality.

At block 715, the apparatus may attempt to setup a connection with the second apparatus over the NDL based on the selected frequency band. For example, referring to FIG. 2A, the STA 208 may attempt to setup a connection with the STA 202 over the NDL based on the selected frequency band. In some aspects, the STA 208 may attempt to setup the connection by transmitting an association request to the STA 202 and by determining whether the STA 202 is available for connection setup over the selected frequency band. If the STA 202 is not available at the selected frequency band, then the STA 208 may select a different frequency band from the frequency band information and attempt to setup the connection based on the selected different frequency band.

At block 720, the apparatus may receive one or more periods indicating when the second apparatus is available for connection setup on the received frequency band information. The attempt to communicate with the second apparatus may be based on the received one or more times. For example, referring to FIG. 2A, the STA 208 may receive one or more periods indicating when the STA 202 is available for connection setup.

At block 725, the apparatus may provide a second message to the second apparatus indicating the attempt to setup the connection with the second apparatus based on the received frequency band information was unsuccessful. For example, referring to FIG. 2A, the STA 208 may transmit a second message to the STA 202 indicating that the attempt to setup the connection with the STA 202 was unsuccessful.

At block 730, the apparatus may provide a link quality report based on the determined link quality. The link quality report may indicate at least one of an indication of whether the link supports a data rate or antenna feedback information based on a millimeter wave beam selection protocol. For example, referring to FIG. 2A, the STA 208 may transmit a link quality report to the STA 202 based on the determined link quality between the STA 202 and the STA 208.

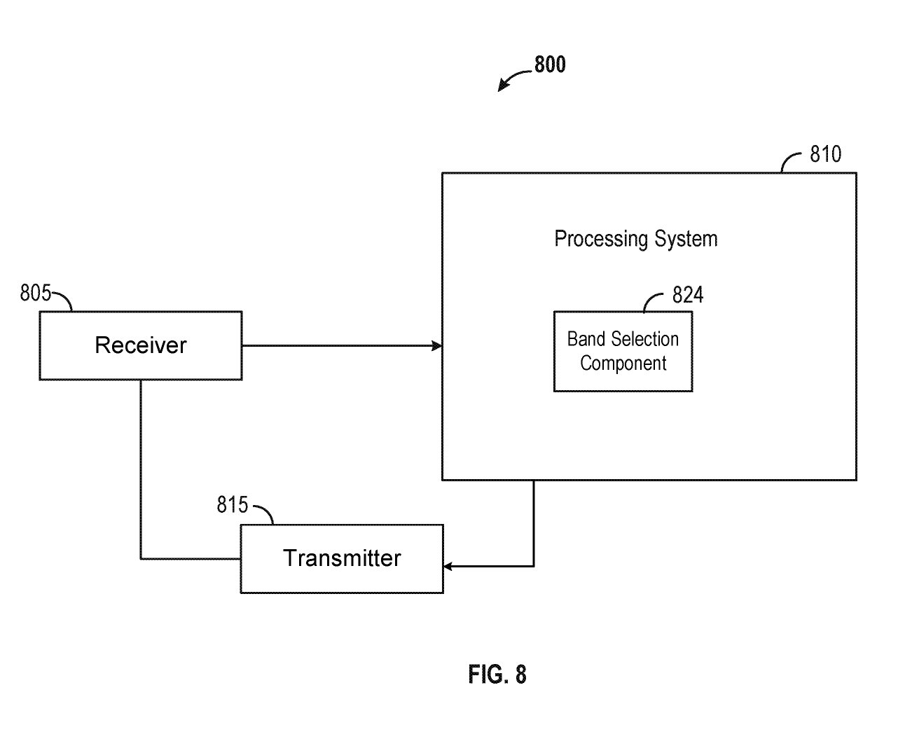

FIG. 8 is a functional block diagram of an example wireless communication device 800 that provides information for and performs band selection. The wireless communication device 800 may include a receiver 805, a processing system 810, and a transmitter 815. The processing system 810 may include a band selection component 824.

In some implementations, the processing system 810 or the band selection component 824 may be configured to determine frequency band information for communicating over an NDL associated with a NAN service. The transmitter 815, the processing system 810, or the band selection component 824 may be configured to provide the determined frequency band information for transmission to a subscriber of the NAN service for setting up the NDL. In some aspects, the determined frequency band information may be transmitted in a publish message. In some other aspects, the transmission of the publish message may be unsolicited.

In some other aspects, the receiver 805, the processing system 810, or the band selection component 824 may be configured to receive a service discovery message from the subscriber. The determined frequency band information may be transmitted in response to the received service discovery message. In some other aspects, the determined frequency band may be indicated in a usage preference subfield of an entry control field within an availability entry attribute that is included within the publish message.

In some other aspects, the transmitter 815, the processing system 810, or the band selection component 824 may be configured to provide one or more periods indicating when the wireless communication device 800 is available for connection setup based on the determined frequency band information. In some other aspects, the transmitter 815, the receiver 805, the processing system 810, or the band selection component 824 may be configured to perform connection setup with the subscriber of the NAN service. In some other aspects, the connection setup for the NDL may be successful on a frequency band indicated in the frequency band information. In this aspect, the NDL may be established on the frequency band, and the frequency band may be different from a second frequency band on which the frequency band information was transmitted.

In some other aspects, the transmitter 815, the receiver 805, the processing system 810, or the band selection component 824 may be configured to perform connection setup by determining that the subscriber is attempting to setup the NDL on a first frequency band that is different from a second frequency band indicated by the frequency band information, by determining a link quality associated with a link over the first frequency band, and by determining whether to reject the connection setup based on the determined link quality associated with the first frequency band.

In some other aspects, the transmitter 815, the receiver 805, the processing system 810, or the band selection component 824 may be configured to perform connection setup by providing an indication, based on the determination to reject the connection setup, that the subscriber is to retry connection setup on one of the frequency bands indicated in the frequency band information.

In some other aspects, the transmitter 815, the receiver 805, the processing system 810, or the band selection component 824 may be configured to perform connection setup by determining a link quality associated with a link over a frequency band. In this aspect, the link quality is determined based on an exchange of null data packets that include channel training symbols. In a further aspect, transmitter 815, the processing system 810, or the band selection component 824 may be further configured to provide a link quality report based on the determined link quality. The link quality report may indicate at least one of an indication of whether the link supports a data rate or antenna feedback information based on a millimeter wave beam selection protocol.

In some other aspects, the receiver 805, the processing system 810, or the band selection component 824 may be configured to receive a link quality report. In some other aspects, the link quality report may indicate that a link quality of a connection associated with at least one frequency band included in the frequency band information is below a threshold and that connection setup for the NDL is to be attempted on a different frequency band. In some other aspects, the connection setup for the NDL may be successful on the different frequency band, and the NDL may be established on the different frequency band.

In some other aspects, the transmitter 815, the processing system 810, or the band selection component 824 may be configured to provide an indication of connection setup failure if connection setup failure is detected, and the indication may include a reason code for the connection setup failure. In some other aspects, the determined frequency band information may be transmitted in a service descriptor extension attribute.

For example, means for determining frequency band information may include the processing system 810 or the band selection component 824. Means for providing the determined frequency band information may include the transmitter 815, the processing system 810, or the band selection component 824. Means for receiving a service discovery message may include the receiver 805, the processing system 810, or the band selection component 824. Means for providing one or more times may include the transmitter 815, the processing system 810, or the band selection component 824. Means for performing connection setup may include the transmitter 815, the receiver 805, the processing system 810, or the band selection component 824. Means for providing a link quality report may include the transmitter 815, the processing system 810, or the band selection component 824. Means for receiving a link quality report may include the receiver 805, the processing system 810, or the band selection component 824. Means for providing an indication of connection setup failure may include the transmitter 815, the processing system 810, or the band selection component 824.

In some other implementations, the receiver 805, the processing system 810, or the band selection component 824 may be configured to receive, from a second apparatus, a message that includes frequency band information for communicating over an NDL associated with a NAN service. The processing system 810 or the band selection component 824 may be configured to select a frequency band for communicating over the NDL based on the received frequency band information.

The receiver 805, the transmitter 815, the processing system 810, or the band selection component 824 may be configured to attempt to setup a connection with the second apparatus over the NDL based on the selected frequency band. In some aspects, the receiver 805, the transmitter 815, the processing system 810, or the band selection component 824 may be configured to attempt to setup the connection by determining whether the second apparatus is available for connection setup over the selected frequency band, by selecting a different frequency band from the frequency band information if the second apparatus is unreachable on the selected frequency band, and by attempting to setup the connection with the second apparatus based on the selected different frequency band. In some other aspects, the receiver 805, the transmitter 815, the processing system 810, or the band selection component 824 may be further configured to attempt to setup the connection by selecting another frequency band that is different from any frequency band indicated by the frequency band information and by attempting to setup the connection with the second apparatus based on the selected other frequency band.

In some other aspects, the transmitter 815, the processing system 810, or the band selection component 824 may be further configured to provide a second message to the second apparatus indicating the attempt to setup the connection with the second apparatus based on the received frequency band information was unsuccessful. In some other aspects, the receiver 805, the processing system 810, or the band selection component 824 may be further configured to receive one or more periods indicating when the second apparatus is available for connection setup on the received frequency band information. The attempt to communicate with the second apparatus may be based on the received one or more times. In some other aspects, the receiver 805, the processing system 810, or the band selection component 824 may be further configured to receive a message rejecting a connection setup with the second apparatus. The message may indicate that the wireless communication device 800 is to retry connection setup on one of the frequency bands indicated in the received frequency band information.

In some other aspects, the transmitter 815, the receiver 805, the processing system 810, or the band selection component 824 may be configured to attempt to setup the connection by determining if the wireless communication device 800 is able to communicate with the second apparatus on the selected frequency band and by determining a link quality with the second apparatus based on the selected frequency band if the wireless communication device 800 is able to communicate with the second apparatus on the selected frequency.

In some other aspects, the transmitter 815, the receiver 805, the processing system 810, or the band selection component 824 may be further configured to attempt to setup the connection by selecting a different frequency band based on the determined link quality and by providing a link quality report to the second apparatus based on the determined link quality. In some other aspects, the link quality may be determined based on QoS null frames, NDPs, or directional multi-gain beam training frames, or other frames.

In some other aspects, the transmitter 815, the processing system 810, or the band selection component 824 may be further configured to provide a link quality report based on the determined link quality. The link quality report may indicate at least one of an indication of whether the link supports a data rate or antenna feedback information based on a millimeter wave beam selection protocol.

In some other aspects, the transmitter 815, the processing system 810, or the band selection component 824 may be further configured to provide an indication of connection setup failure if connection setup failure is detected. The indication may include a reason code for the connection setup failure. In some other aspects, the indication of connection setup failure may be transmitted on a channel previously used for communication between the wireless communication device 800 and the second apparatus. In some other aspects, the indication of connection setup failure may be transmitted during a discovery window of the NAN.

For example, means for receiving, from a second apparatus, a message may include the receiver 805, the processing system 810, or the band selection component 824. Means for selecting a frequency band may include the processing system 810 or the band selection component 824. Means for attempting to setup a connection may include the transmitter 815, the receiver 805, the processing system 810, or the band selection component 824. Means for providing a second message may include the transmitter 815, the processing system 810, or the band selection component 824. Means for receiving one or more times may include the receiver 805, the processing system 810, or the band selection component 824. Means for providing a link quality report may include the transmitter 815, the processing system 810, or the band selection component 824. Means for providing an indication of connection setup failure may include the transmitter 815, the processing system 810, or the band selection component 824.

The receiver 805 may correspond to the receiver 512. The processing system 810 may correspond to the processor 504. The transmitter 815 may correspond to the transmitter 510. The band selection component 824 may correspond to the band selection component 124, the band selection component 126, or the band selection component 524.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that utilizes an “association request” by one of the apparatus followed by an “association response” by the other apparatus. It will be understood by those skilled in the art that the handshake protocol may utilize other signaling, such as by way of example, signaling to provide authentication.

What is claimed is:

1. An apparatus for wireless communication, comprising:
a processing system configured to:
determine frequency band information for communicating over a neighbor awareness networking (NAN) data link (NDL) associated with a NAN service; and
provide the determined frequency band information for transmission to a subscriber of the NAN service for setting up the NDL.

2. The apparatus of claim 1, wherein the processing system is further configured to receive a service discovery message from the subscriber, and wherein the determined frequency band information is transmitted in response to the received service discovery message.

3. The apparatus of claim 1, wherein the determined frequency band information is transmitted in a publish message, wherein the determined frequency band information is included in a usage preference subfield of an entry control field within an availability entry attribute that is included within the publish message, and wherein the usage preference subfield indicates a ranking of one or more frequency bands among possible frequency bands for connection setup.

4. The apparatus of claim 3, wherein the processing system is further configured to:
provide one or more periods indicating when the apparatus is available for connection setup based on the determined frequency band information.

5. The apparatus of claim 4, wherein the connection setup for the NDL is successful on a frequency band indicated in the frequency band information, the NDL is established on the frequency band, and the frequency band is different from a second frequency band on which the frequency band information was transmitted.

6. The apparatus of claim 4, wherein the processing system is configured to perform connection setup by determining a link quality associated with a link over a frequency band.

7. The apparatus of claim 6, wherein the link quality is determined based on an exchange of null data packets that include channel training symbols.

8. The apparatus of claim 6, wherein the processing system is further configured to provide a link quality report based on the determined link quality, wherein the link quality report indicates at least one of an indication of whether the link supports a data rate or antenna feedback information based on a millimeter wave beam selection protocol.

9. The apparatus of claim 1, wherein the processing system is configured to provide an indication of connection setup failure if connection setup failure is detected, and wherein the indication includes a reason code for the connection setup failure.

10. An apparatus for wireless communication, comprising:
a processing system configured to:
receive, from a second apparatus, a message that comprises frequency band information for communicating over a neighbor awareness networking (NAN) data link (NDL) associated with a NAN service;
select a frequency band for communicating over the NDL based on the received frequency band information; and
attempt to setup a connection with the second apparatus over the NDL based on the selected frequency band.

11. The apparatus of claim 10, wherein the processing system is configured to attempt to setup the connection by:
determining whether the second apparatus is available for connection setup over the selected frequency band;
selecting a different frequency band from the frequency band information if the second apparatus is unreachable on the selected frequency band; and
attempting to setup the connection with the second apparatus based on the selected different frequency band.

12. The apparatus of claim 11, wherein the processing system is further configured to provide a second message to the second apparatus indicating the attempt to setup the connection with the second apparatus based on the received frequency band information was unsuccessful.

13. The apparatus of claim 10, wherein the processing system is further configured to receive one or more periods indicating when the second apparatus is available for connection setup on the received frequency band information, wherein the attempt to communicate with the second apparatus is based on the received one or more times.

14. The apparatus of claim 10, wherein the processing system is further configured to receive a message rejecting a connection setup with the second apparatus, wherein the message indicates that the apparatus is to retry connection setup on one of the frequency bands indicated in the received frequency band information.

15. The apparatus of claim 10, wherein the processing system is configured to attempt to setup the connection by:
determining if the apparatus is able to communicate with the second apparatus on the selected frequency band; and
determining a link quality with the second apparatus based on the selected frequency band if the apparatus is able to communicate with the second apparatus on the selected frequency.

16. The apparatus of claim 15, wherein the processing system is further configured to attempt to setup the connection by:
selecting a different frequency band based on the determined link quality; and
providing a link quality report to the second apparatus based on the determined link quality.

17. The apparatus of claim 15, wherein the link quality is determined based on quality of service (QoS) null frames, null data packets (NDPs), or directional multi-gain beam training frames, or other frames.

18. The apparatus of claim 15, wherein the processing system is further configured to provide a link quality report based on the determined link quality, wherein the link quality report indicates at least one of an indication of whether the link supports a data rate or antenna feedback information based on a millimeter wave beam selection protocol.

19. The apparatus of claim 18, wherein the processing system is further configured to provide an indication of connection setup failure if connection setup failure is detected, and wherein the indication includes a reason code for the connection setup failure.

20. A method for wireless communication, comprising:
determining frequency band information for communicating over a neighbor awareness networking (NAN) data link (NDL) associated with a NAN service; and
providing the determined frequency band information for transmission to a subscriber of the NAN service for setting up the NDL.

21. The method of claim 20, further comprising receiving a service discovery message from the subscriber, wherein the determined frequency band information is transmitted in response to the received service discovery message.

22. The method of claim 20, wherein the determined frequency band information is transmitted in a publish message, wherein the determined frequency band information is included in a usage preference subfield of an entry control field within an availability entry attribute that is included within the publish message, and wherein the usage preference subfield indicates a ranking of one or more frequency bands among possible frequency bands for connection setup.

23. The method of claim 22, wherein the connection setup for the NDL is successful on a frequency band indicated in the frequency band information, the NDL is established on the frequency band, and the frequency band is different from a second frequency band on which the frequency band information was transmitted.

24. The method of claim 23, further comprising performing the connection setup by determining a link quality associated with a link over a frequency band.

25. The method of claim 20, wherein the determined frequency band information is transmitted in a service descriptor extension attribute.

26. A method for wireless communication, comprising:
receiving, from a second apparatus, a message that comprises frequency band information for communicating over a neighbor awareness networking (NAN) data link (NDL) associated with a NAN service;
selecting a frequency band for communicating over the NDL based on the received frequency band information; and
attempting to setup a connection with the second apparatus over the NDL based on the selected frequency band.

27. The method of claim 26, wherein the attempting to setup the connection comprises:
determining whether the second apparatus is available for connection setup over the selected frequency band;
selecting a different frequency band from the frequency band information if the second apparatus is unreachable on the selected frequency band; and
attempting to setup the connection with the second apparatus based on the selected different frequency band.

28. The method of claim 26, wherein the attempting to setup the connection comprises:
determining if the apparatus is able to communicate with the second apparatus on the selected frequency band; and
determine a link quality with the second apparatus based on the selected frequency band if the apparatus is able to communicate with the second apparatus on the selected frequency.

29. The method of claim 28, wherein the attempting to setup the connection further comprises:
selecting a different frequency band based on the determined link quality; and
providing a link quality report to the second apparatus based on the determined link quality.

30. The method of claim 28, wherein the link quality is determined based on quality of service (QoS) null frames, null data packets (NDPs), or directional multi-gain beam training frames, or other frames.
